(19) United States
(12) Patent Application Publication
(10) Pub. No.: US 2021/0204496 A1
(43) Pub. Date: Jul. 8, 2021

(54) SYSTEM AND METHOD OF WATERING CROPS WITH A VARIABLE RATE IRRIGATION SYSTEM

(71) Applicant: The United States of America, as represented by the Secretary of Agriculture, Washington, DC (US)

(72) Inventors: MANUEL A. Andrade, AMARILLO, TX (US); SUSAN A. OSHAUGHNESSY, AMARILLO, TX (US); STEVEN R. Evett, AMARILLO, TX (US)

(21) Appl. No.: 17/141,647

(22) Filed: Jan. 5, 2021

Related U.S. Application Data
(60) Provisional application No. 62/958,469, filed on Jan. 8, 2020.

(51) Int. Cl. A01G 25/16; G05B 19/042

(52) U.S. Cl. CPC A01G 25/165; G05B 2219/2625; G05B 19/042

(57) ABSTRACT

The system and method of watering crops with a variable rate irrigation system provides a means to formulate a watering prescription map even when some required input data is unavailable. In the preferred embodiment, the unavailable input data is measured canopy temperature data from infrared thermometers mounted on a center pivot irrigation pipe. The system is the irrigation scheduling supervisory control and data acquisition system (ISSCADAS) and the method is an Artificial Neural Network (ANN) modeling method that substitutes data from trained existing data sets to estimate the unavailable variable when actual variable measurements are missing or invalid.

### REFERENCE TO RELATED APPLICATIONS

This application claims the benefit of U.S. Provisional Application No. 62/958,469, filed Jan. 8, 2020, which is incorporated herein by reference in its entirety.

### FIELD OF THE INVENTION

The disclosed system and method relate to using a variable rate irrigation (VRI) system equipped with an Irrigation Scheduling Supervisory Control and Data Acquisition System (ISCCADAS) to irrigate crops. Specifically, the method and system described herein relates to substituting conventionally-gathered infrared thermometer temperature (IRT) data with infrared temperature data generated by a machine learning algorithm.

### BACKGROUND OF THE INVENTION

Agriculture, like many other economic sectors, is rapidly transitioning from traditional simple mechanical systems, to systems that are electronically controllable and automated. These systems are designed to optimize the use of resources like water, energy, pesticide, herbicide, fertilizer, etc., to maximize productivity, save money, and to benefit the environment. One of the tools that has been successfully adapted to more efficiently (at least) irrigate crops is a variable rate irrigation (VRI) system. A schematic of a VRI system is generally shown in FIG. 1. In a state-of-the-art system, the VRI is equipped with an Irrigation Scheduling Supervisory Control and Data Acquisition System (ISSCADAS) patented by the US Department of Agriculture (USDA) (U.S. Pat. No. 8,924,031 to Evett, hereinafter “Evett '031”, which is hereby incorporated by reference). The ISSCADAS (among other things) automatically generates irrigation prescription maps for application by VRI center pivot systems. A software package, named ARS-Pivot (ARSP), was developed by the USDA to simplify the operation of the ISSCADAS. Essentially, the ISSCADAS collects data from soil, water, plant, and weather sensing systems—and feeds the data to electronic irrigation scheduling algorithms implemented in the ARSP software to generate site-specific irrigation prescription maps. A network of infrared thermometers (IRTs) mounted on the pipeline of a VRI center pivot system is particularly critical to the ISSCADAS since the IRTs measure canopy temperatures as the center pivot traverses the field, and the ISSCADAS uses these temperatures to estimate crop water needs. However, blowing dust, fog, technical issues and a variety of other obstructions/complications can prevent the IRTs from effectively gathering data and/or communicating with the ISSCADAS. The need exists for a reliable means of supplying usable/accurate IRT data to the ISSCADAS in the event that one or all of IRT center pivot sensors is unable to provide the required data.

The system disclosed herein comprises a modified ISSCADAS system that includes a data module capable of supplying projected IRT data when field-based measurements or technical issues prevent direct measurement of the canopy temperatures by one or more of the network IRTs. In accordance with the current invention, the inventors use a machine learning algorithm, known as an Artificial Neural Network (ANN), trained with complete data sets of canopy temperatures obtained from a fully operational network of IRTs to produce/generate a “model”. When the available weather and system information is plugged into the model, the model will produce the estimated IRT data. The estimated IRT data can be used by the ARSP software package in the ISSCADAS in the event that contemporaneously-gathered data from IRT sensors is not available. The availability of such a tool can add redundancy to the ISSCADAS so that site-specific prescription maps can be generated even if a direct measurement of canopy temperatures is not reasonably practicable/possible.

In addition to the IRT data associated with the IRTs on the pipeline of a VRI center pivot system, in alternative embodiments, Crop Water Stress Index (iCWSI) values, temperature data from field (stationary) IRTs, and other irrigation variables can also be estimated using ANNs.

### SUMMARY OF THE INVENTION

In the preferred embodiment, this disclosure is directed to a machine learning algorithm in the form of an Artificial Neural Network (ANN) to estimate crop leaf canopy temperatures when the crop leaf canopy temperatures cannot be measured by a network of infrared thermometers (IRTs) mounted on the pipeline of a center pivot irrigation system. These temperatures are used by a decision support system (DSS) created by USDA scientists to help farmers to determine when, where and how much to irrigate in different parts of a field using a variable rate irrigation (VRI) center pivot system. The gathering of crop leaf temperatures by the network of IRTs depends on the center pivot moving across the field, on the proper functioning of IRTs, and on the existence of appropriate conditions for the accurate measurement of canopy temperatures by the IRTs. In cases where these conditions cannot be met, an ANN system previously trained using past crop temperature data and weather information (among other things) can be used to estimate the current spatial temperature data.

### BRIEF DESCRIPTION OF THE DRAWINGS

The patent or application file associated with this disclosure contains at least one drawing executed in color. Copies of this patent or patent application publication with color drawing(s) will be provided by the Office upon request and payment of the necessary fee.

FIG. 1 is a schematic of a center-pivot VRI system.

FIG. 2 is a flow chart for generating irrigation prescription maps according to the current invention.

FIG. 3 is a schematic arrangement of elements in an ANN used to predict canopy temperature in accordance with the preferred embodiment.

FIG. 4 is the example experimental setup as displayed in the ARSP software. Numbers inside of plots preceded by the letter ‘p’ indicate the numbers used to identify plots. Squares represent the approximate location of soil water sensors (TDRs). Two-small circles inside a well irrigated area (w1) indicate the approximate location of field IRTs. A solid (red) line represents the position of the center pivot and small triangles next to this line indicate the location of IRTs mounted on the center pivot.

FIGS. 5-10 are a time series of canopy temperatures measured by IRTs and estimated by ANNs trained to forecast the average temperatures obtained by IRT groups a) through f) (1-6 respectively) during Jul. 12, 2017 (DOY 193). IRT group 1 (FIG. 5) consists of the two IRTs closest to the pivot point, and IRT group 6 (FIG. 10) consists of the two IRTs farthest from the pivot point. ANNs were trained using data collected during the first three scans that took place on June 26, July 7, and Jul. 11, 2017. In FIGS. 5-10 the dark circles represent measured canopy temperature and the hollow circles represent temperature estimated by ANN.

FIGS. 11-16 are a time series of canopy temperatures measured by IRTs and estimated by ANNs trained to forecast the average temperatures obtained by IRT groups a)-f) (1-6 respectively) during Jul. 24, 2017 (DOY 205). IRT group 1 (FIG. 11) consists of the two IRTs closest to the pivot point, and IRT group 6 (FIG. 16) consists of the two IRTs farthest from the pivot point. ANNs were trained using data collected during the first six scans that took place on June 26, July 7, July 11, July 12, July 17, and Jul. 20, 2017. In FIGS. 11-16 the dark circles represent measured canopy temperature and the hollow circles represent temperature estimated by ANN.

FIG. 17 shows two prescription maps generated using canopy temperatures a) measured by a network of wireless IRTs mounted on the center pivot and b) estimated by ANNs using data collected on Jul. 24, 2017 (DOY 205). Prescriptions are displayed as percentages of a pre-specified maximum irrigation depth. Only one plot (p8) received a different prescription when using the canopy temperatures estimated by ANNs.

### DETAILED DESCRIPTION OF PREFERRED EMBODIMENTS

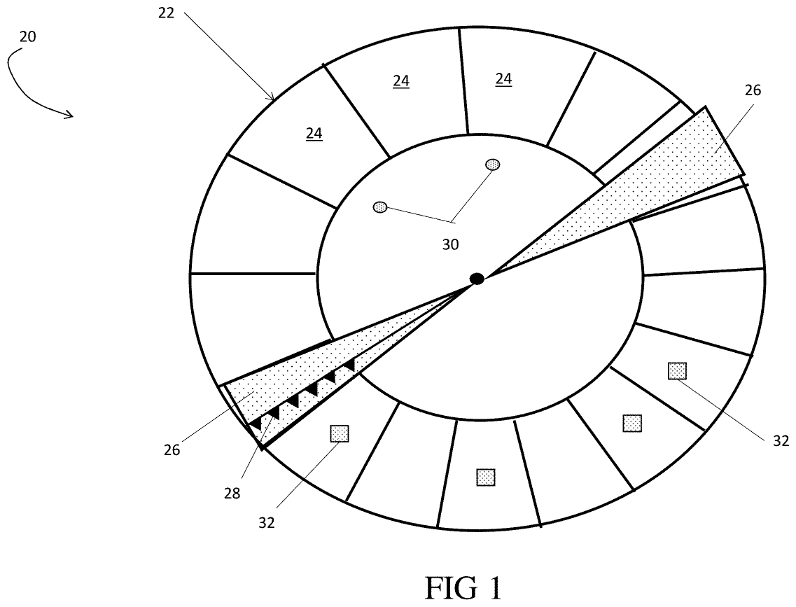

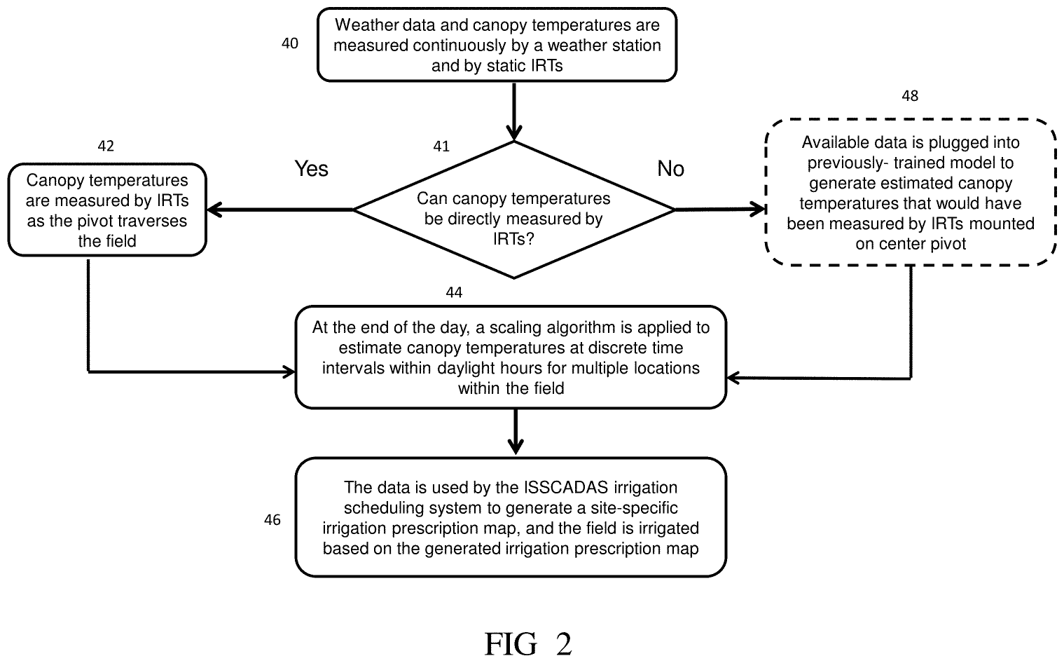

FIG. 1 shows a schematic of a center-pivot VRI system as described in greater detail in the Evett '031 patent. FIG. 2 is a flow chart that shows the operation of the VRI system (per the preferred embodiment) as modified by the subject matter of the current disclosure. Specifically, the Evett '031 patent assumes that field conditions are clear and that all of the environmental sensors can communicate with the ISSCADAS. However, in operation, the IRT sensors may become non-functional because the sensors are obscured by environmental elements (moisture, dust, etc.) or are otherwise technically unable to transmit accurate data to the ISSCADAS. The current method includes modifications that enable the ISSCADAS to function even without input from the IRT sensors. Note that while the ISSCADAS is primarily discussed, other automated irrigation scheduling and control data acquisition systems should be considered within the scope of this disclosure.

As shown in FIG. 1, in a conventional ISSCADAS-based center pivot irrigation system 20, the field 22 is generally circular and may be divided and into multiple sections 24 to more accurately identify specific areas of the field 22. Note for the sake of simplicity, only the basic sections 24 are shown in FIG. 1. However, for increased precision, the sections 24 may be divided further into subsections and increasingly smaller plots, as required for a specific precision installation.

In operation, the irrigation system 20 typically comprises a center pivoting mechanism 26 that includes a network of irrigation nozzles fed by a supporting fluid circulation system that actually irrigates the crops. In the preferred embodiment, the center pivot 26 also includes IRTs 28 that move with the center pivot 26 as it sweeps around the field 22. The system 20 may also include a series of static IRTs 30 as well as soil-moisture sensors 32. In the preferred embodiment, the soil-moisture sensors are Time Domain Reflectometry (TDR)—type sensors.

The flow chart shown in FIG. 2 generally describes the data gathering process. At the beginning and throughout the day, weather data is collected from a weather station that is co-located within the irrigation site, as described in FIG. 2 element 40. The weather data generally comprises: outside air temperature, relative humidity, solar irradiance, wind speed (and direction), and any other weather-related variables deemed relevant by system operators. Other variables may include crop type, the number of days since the crop was originally planted, the amount of rainfall in the previous five days, and other data associated with plant treatment and irrigation, as well as any additional considerations associated with a specific operation.

As indicated FIG. 2 element 41, the ISSCADAS automatically determines if the IRT hardware can communicate with the ISSCADAS and gather canopy temperatures. If the answer to the element 41 query is “yes”, then plant canopy temperature is measured directly by the center pivot IRTs 28 (see FIG. 1), as described in FIG. 2 element 42. At the end of a selected day (i.e. midnight), a scaling algorithm is applied to estimate canopy temperatures at discrete time intervals within daylight hours for multiple locations within the field 22, per FIG. 2 element 44. The temperature data are used by the ISSCADAS irrigation scheduling algorithm to generate a recommended site-specific irrigation prescription map. The generated irrigation prescription map is then used (subject to operator modification) to irrigate the target field.

However, as noted above, if conditions are not ideal, and the answer to the decision question posed in the FIG. 2 decision box 41 is “no”, then a previously-trained “model” is used to estimate the temperature of the plant canopy as if the temperature had actually been measured by the designated IRTs, as described in FIG. 2 element 48. In the preferred embodiment, the model is generated by an artificial neural network. After the model is developed and the temperature data is generated, the process continues as described in FIG. 2 decision boxes 44 and 46.

### Artificial Neural Network (ANN)

The inventors generally conducted two case studies to analyze the feasibility of using an ANN-based model for the purpose of estimating IRT input to the ISSCADAS. Although the case studies focused on estimating the IRT input for the IRTs positioned on the center pivot irrigation pipe, these methods can be used to estimate other irrigation variables.

In the first case, six ANN “models” (one for each of the six pairs of IRTs with opposing views located on the center pivot) were trained using data collected during the first three dates when the center pivot traversed the field to gather crop canopy temperatures (referred to as scans). Since the training of ANNs yields different results every time, multiple ANNs were trained for each pair of IRTs and the best performing ANN was then selected to be used as the “model” for estimating IRT input. The accuracy of each “model” was then assessed by predicting average canopy temperatures that would be measured by its corresponding pair of IRTs during the following scan.

In the second case, six ANN “models” were trained using data collected during the first six scans. Multiple ANNs were also trained for each pair of IRTs and the best performing ANN was selected to be used for the forecasting of average canopy temperatures that would be measured by its corresponding pair of IRTs during the following scan.

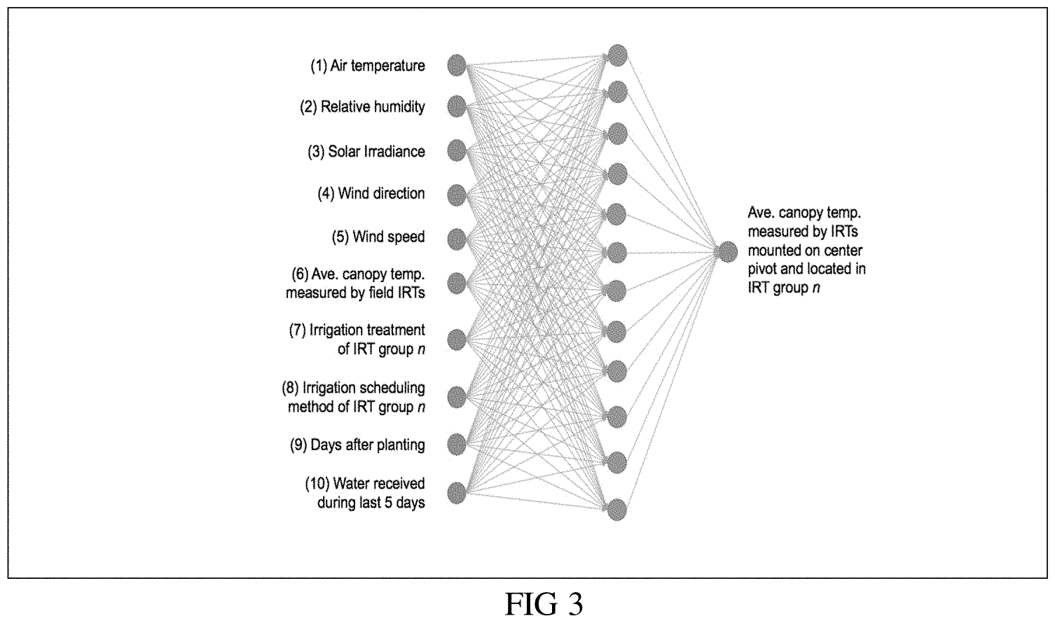

The typical structure of an ANN (also known as architecture) is composed of at least three layers of nodes (usually referred to as neurons) and the links between these layers (FIG. 3). The first layer is the input layer, the last one is the output layer, and all others are hidden layers. Nodes in these layers are referred to as input neurons, output neurons, and hidden neurons, respectively. ANNs used by the inventors had 10 input neurons, corresponding to the number of variables that were considered relevant for the estimation of average crop canopy temperatures estimated by a given pair of IRTs mounted on the center pivot. As shown in FIG. 3, these variables were: (1) air temperature measured at time t during a scan, (2) relative humidity at time t, (3) solar irradiance at time t, (4) wind direction at time t, (5) wind speed at time t, (6) average canopy temperature measured by stationary IRTs at time t, (7) irrigation level (%) assigned to the experimental plot p being scanned by a pair of IRTs at time t, (8) irrigation scheduling method assigned to plot p, (9) number of days passed since planting at the time of the scan, and (10) cumulative irrigation (including precipitation) received by a selected experimental plot p. Additional variables may be required in different embodiments.

For the purposes of this disclosure, the term “irrigation variable” comprises at least the average canopy temperature measured by IRTs mounted on center pivot and located in IRT group n, and the other variables listed in the previous paragraph and in FIG. 3, either alone or in combination with the listed variables. For the purposes of this disclosure, Crop Water Stress Index (iCWSI) values may be considered an irrigation variable. An irrigation variable can also comprise any other unlisted variables (either alone or in combination) that are relevant to the construction of an irrigation plan/irrigation prescription map.

Generic ANNs are known in the art. ANNs with a single output neuron are known in the art to be better estimators than ANNs with multiple output neurons—and thus a single output neuron output was selected by the inventors. Specifically, the inventors selected the variable “average canopy temperature” measured by a given pair of IRTs 28 (see FIG. 1) mounted on the center pivot 26 as the output neuron/“selected value of interest”, although other variables or groups of variables should be considered within the scope of the current invention. Using a single output neuron for ANN for the preferred embodiment offers the additional advantage of allowing ANNs to account for conditions that may be exclusive to a single IRT pair, such as scanning a sprinkler zone with a clogged nozzle.

Datasets used for the training of ANNs in the first case study can be represented by an input matrix with dimensions M by N, and an output vector with M elements, where M is the total number of one-minute intervals occurring during the first three scans performed in the growing season, and N is the number of input variables in the ANNs, i.e., 10 (FIG. 3).

Datasets were obtained by (optionally) running the VRI system dry for data gathering purposes. The first row in the input matrix contained the values recorded for each input variable during the first one-minute interval, the second row contained the values recorded during the second interval, and so on. The output vector, on the other hand, contained the average canopy temperatures measured by an IRT pair at each one-minute interval.

### Example

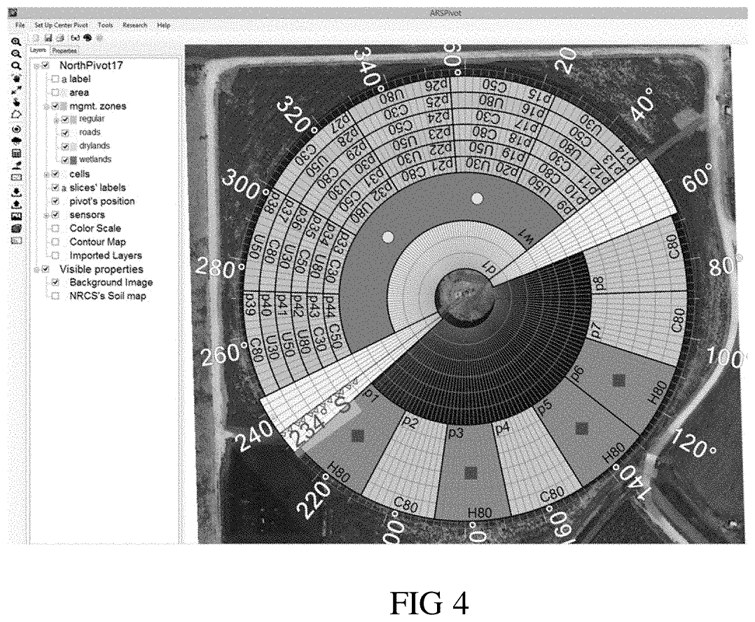

In the summer of 2017, the ISSCADAS and the ARSP software were used for the irrigation management of a three-span center pivot (131 m) irrigation system located at the USDA-ARS Conservation and Production Research Laboratory, near Bushland, Tex. The center pivot was equipped with a Pro2 control panel and a commercial VRI system (Valmont Industries Inc., Valley Nebr.). A midseason corn hybrid, Dupont Pioneer P1151AM, was planted on May 15, day of year (DOY) 135. Experimental plots used in this study were located within the six outermost sprinkler zones in the field shown in FIG. 4.

VRI zone control was used for the North-Northwest (NNW) side of the field, which was divided into six control sectors of 28° each and six concentric control zones with a width of 9.14 m (30 ft) each, for a total of 36 management zones, each of which was considered an experimental plot. As shown in FIG. 4, plots were organized using a Latin square design. VRI speed control was used for the South-Southeast (SSE) side of the field, which was divided into eight control sectors of 20° each and a single concentric control zone with a width of 54.9 m, for a total of 8 management zones, each of which was considered an experimental plot.

The irrigation of plots in the NNW side was triggered by either the integrated Crop Water Stress Index (iCWSI) method (described previously by the inventors, and in U.S. Pat. No. 9,866,768 to O'Shaughnessy et al. (2017), which is hereby incorporated by reference). Irrigation may also be triggered by weekly neutron probe (NP) (model 503DR1.5, Instrotek, Campbell Pacific Nuclear, Concord, Calif.) measurements. Each of these plots was assigned one of the following irrigation levels: 80%, 50%, or 30% of full irrigation. Full irrigation was defined as the irrigation required to return soil water content in the root zone to field capacity. The combination of irrigation scheduling methods (2) and irrigation levels (3) resulted in six treatments with six replicates per treatment. Plots irrigated with the iCWSI method are labeled in FIG. 4 as C80, C50, or C30, where ‘C’ stands for iCWSI-based control and numbers correspond to irrigation levels. Similarly, plots irrigated with the NP method are labeled in FIG. 4 as U80, U50, or U30, where ‘U’ indicates that irrigation scheduling is controlled by the user.

Plots in the SSE side were all assigned a single irrigation level of 80%; their irrigation was triggered by either the iCWSI method, or by a hybrid method using the iCWSI method and an average soil water depletion in the root zone (SWDr) calculated using sets of three time domain reflectometer (TDR) sensors (model 315, Acclima, Meridian, Id.) buried at depths of 15 cm, 30 cm, and 45 cm.

The hybrid method used a two-step approach for irrigation scheduling. During the first step, the SWDr was compared against pre-determined lower and upper SWDr thresholds. No irrigation was assigned if the SWDr was lower than 0.1 (lower threshold) and an irrigation depth of 30.5 mm (1.2 in) was assigned if the SWDr was higher than 0.5 (upper threshold). If the SWDr fell between these values, the iCWSI method was used during a second step to determine its prescription. Plots irrigated with the hybrid method are labeled in FIG. 4 as H80.

The iCWSI method is based on calculation of the theoretical Crop Water Stress Index (CWSI) at discrete intervals during daylight hours. CWSI values were calculated for each location x in the field at time interval t using the normalized difference between the crop canopy temperature in the location and the air temperature at time t. Additional details of the iCWSI method and the formulas used for its calculation are known in the art and can be found in the inventors' previous publications. Temperature and other relevant weather parameters (relative humidity, solar irradiance, wind speed, and wind direction) were sampled every 5 s and averaged and stored every minute at a weather station (Campbell Scientific, Logan, Utah) located next to the pivot point.

Crop canopy temperatures were measured at two fixed locations in the field using wireless IRTs (model SapIP-IRT, Dynamax Inc., Houston, Tex.) to provide a reference canopy temperature for a well-watered crop (FIG. 1). A network of 12 wireless infrared thermometers IRTs was mounted on the center pivot to measure canopy temperatures inside the experimental area shown in FIG. 4. The IRTs were located forward of the drop hoses, at an oblique angle from nadir. The average of data collected from two IRTs with opposing views of a sprinkler control zone was the primary datum every minute for each sprinkler zone.

Scans of the field were performed periodically through the growing season by running the center pivot dry. Weather data and canopy temperatures—measured by the network of stationary IRTs in the field and on the center pivot—collected during scans were used to train ANNs to estimate average canopy temperatures obtained by a given IRT pair with opposing views of a sprinkler zone. Two case studies were conducted to analyze the feasibility of using ANNs for this purpose. In the first case, six types of ANNs (one for each of the six IRT pairs located on the center pivot) were trained using data collected during the first three scans that took place on June 26 (DOY 177), July 7 (DOY 188), and Jul. 11, 2017 (DOY 192).

As described above, since the training of ANNs yields different results every time, 50 ANNs were trained for each ANN type and the best performing ANN among them was then selected to be used for the forecasting of average canopy temperatures that would be measured by the corresponding IRT pair during the following scan (July 12, DOY 193). The accuracy of the best ANN selected for ANN type n was then assessed by predicting average canopy temperatures that would be measured by IRT pair n on this date. As also generally described above, in the second case, six types of ANNs were trained using data collected during the first six scans that, in addition to the previous dates, took place on July 17 (DOY 198), and July 20 (DOY 201). 50 ANNs were also trained for each ANN type and the best performing ANN was selected to be used for the forecasting of average canopy temperatures that would be measured by the corresponding IRT group during the following scan (Jul. 24, 2017 DOY 205).

### Results

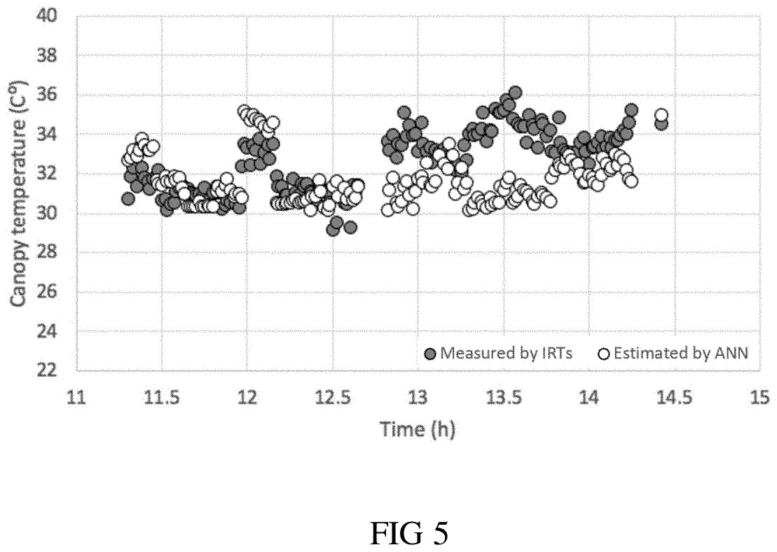

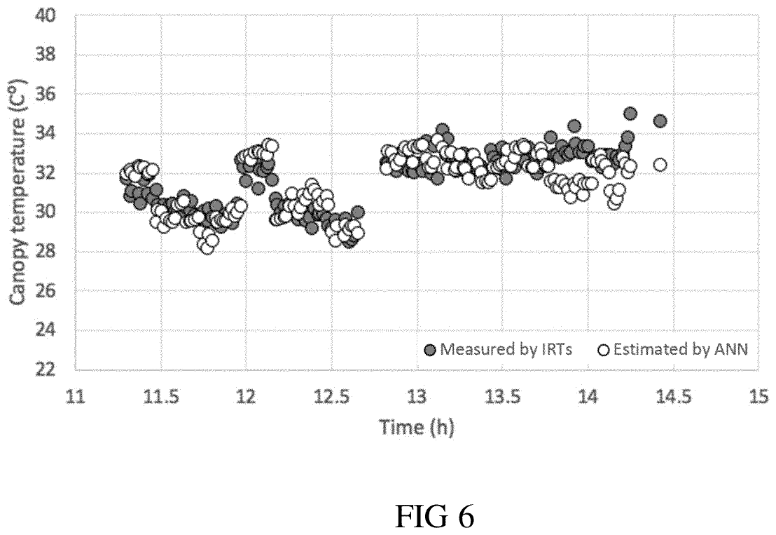

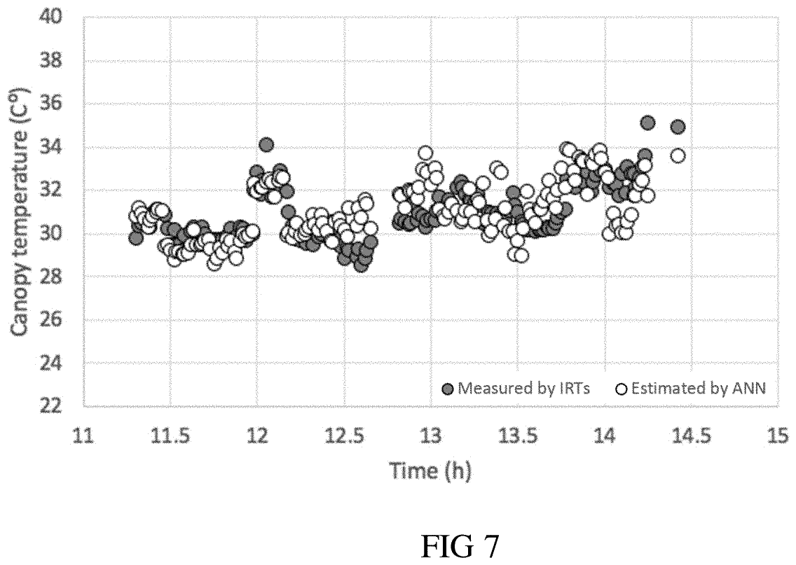

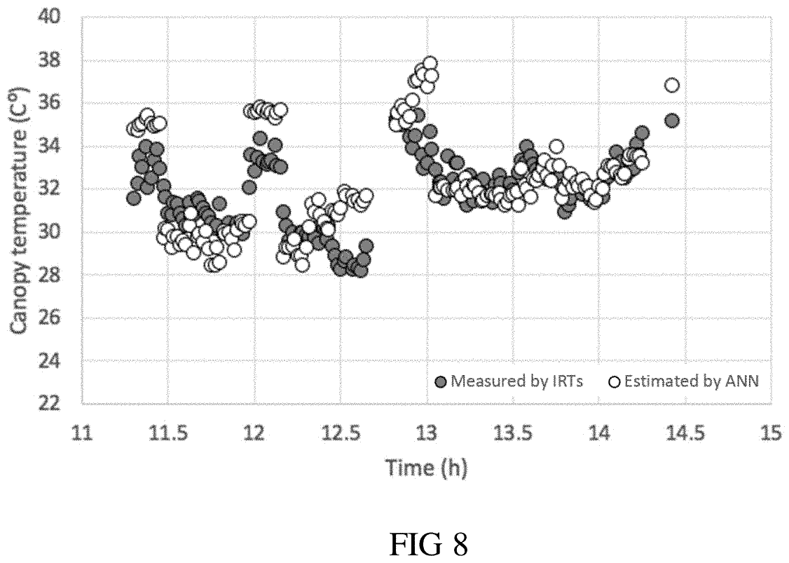

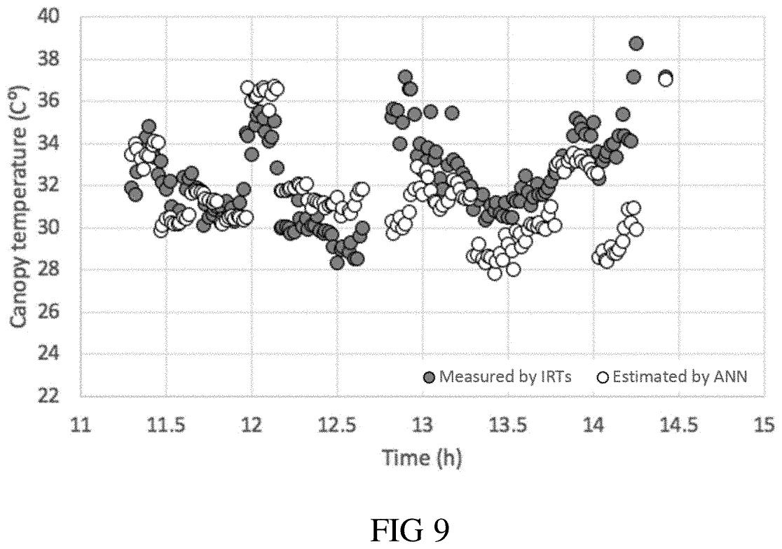

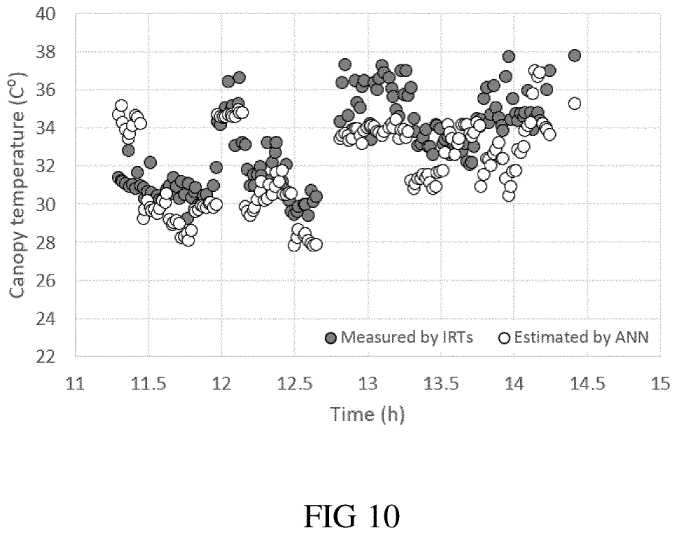

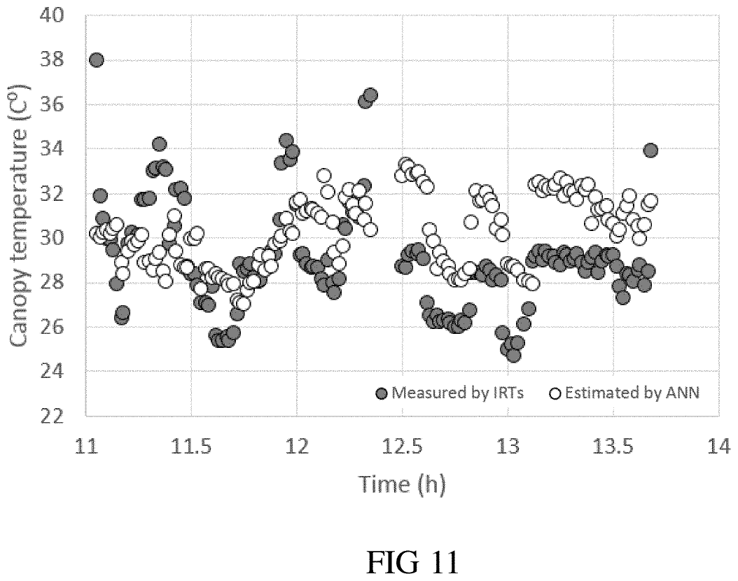

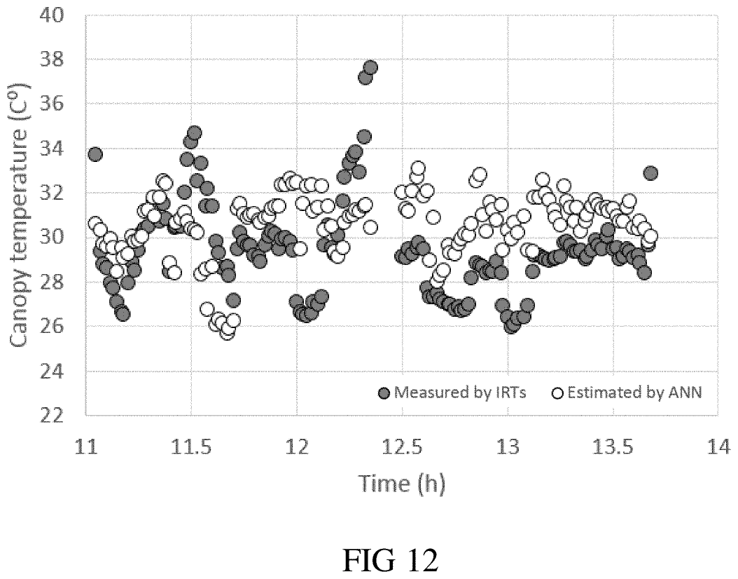

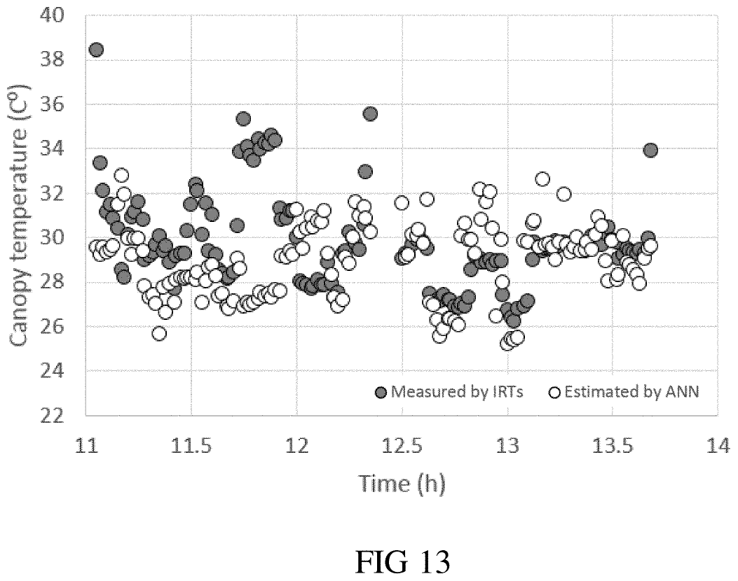

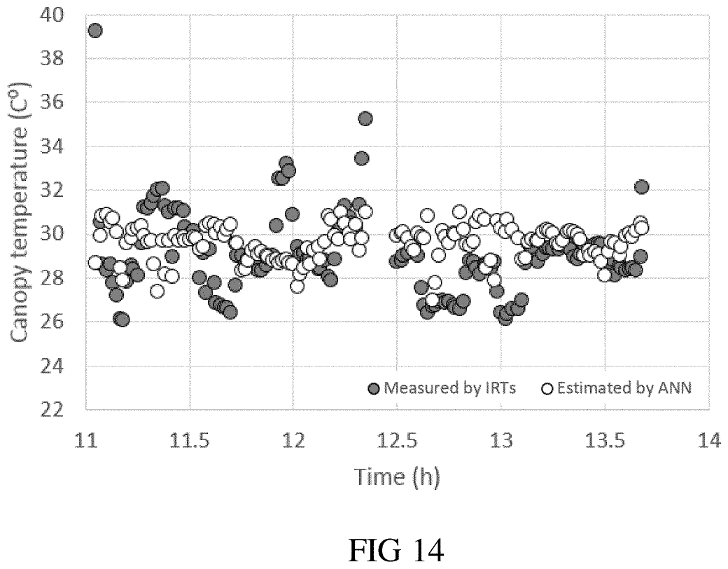

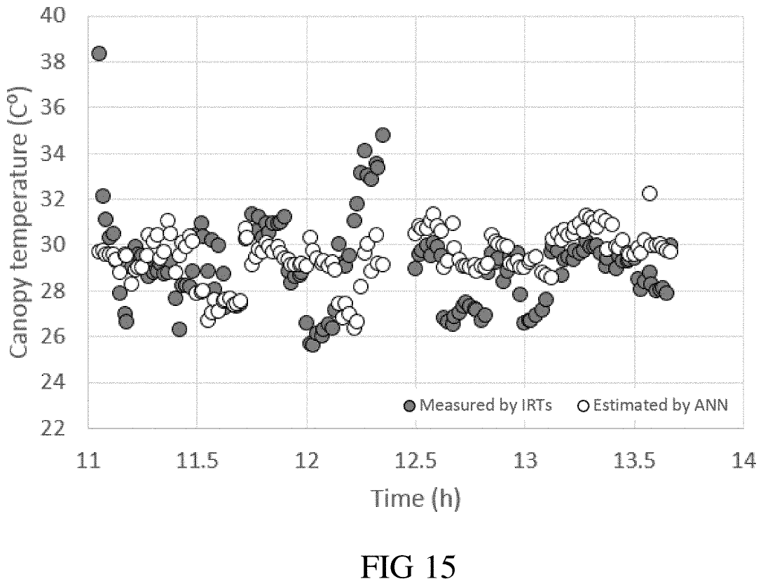

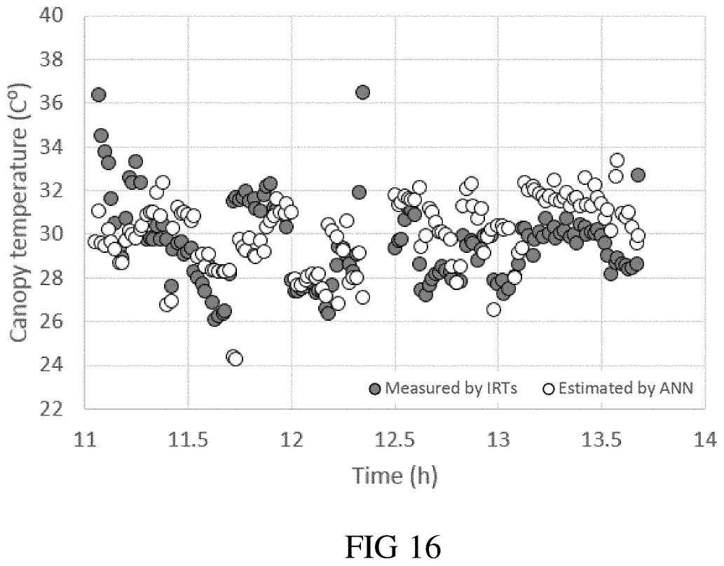

Time series of average crop canopy temperatures estimated by ANNs and measured by IRT pairs mounted on the center pivot are displayed for the first and second cases in FIGS. 5-10, and FIGS. 11-16, respectively. On July 12, the scan started at 11.3 h at an angle of 227°. The center pivot then advanced in a counter-clockwise direction through the SSE side of the field and entered the NNW side at approximately 13 h. The scan was completed at 14.2 h when the pivot reached 248°.

Since all IRT pair scanned experimental plots in the SSE side (where the highest irrigation level was assigned to all plots) before 13 h, measured canopy temperatures before this time tended to be smaller than temperatures obtained in the NNW side (where irrigation levels varied) after this time (FIGS. 5-10). Nevertheless, ANNs were capable of approximating the oscillating pattern displayed by measured canopy temperatures through the scan, with a Root Mean Squared Error (RMSE) that ranged from 1.04° C. to 2.49° C., as shown below in Table 1.

TABLE 1
Root Mean Squared Error (RMSE) of ANNs used in the first
case study to forecast average canopy temperatures measured
by IRT groups during the scan performed on July 12

| | Root Mean Squared Error (RMSE) | | | | | |
|---|---|---|---|---|---|---|
| | IRT | IRT | IRT | IRT | IRT | IRT |
| | Group | Group | Group | Group | Group | Group |
| | 1 | 2 | 3 | 4 | 5 | 6 |
| All irrigation | 2.06 | 1.04 | 1.16 | 1.52 | 2.49 | 2.10 |
| levels | | | | | | |
| 30% irrigation | 1.21 | 1.07 | 1.52 | 0.76 | 4.02 | 1.49 |
| level | | | | | | |
| 50% irrigation | 2.38 | 0.70 | 1.18 | 0.56 | 3.29 | 3.11 |
| level | | | | | | |
| 80% irrigation | 2.14 | 1.11 | 1.03 | 1.84 | 1.58 | 1.91 |
| level | | | | | | |

To assess the impact of using ANNs for irrigation management, their estimated canopy temperatures were used by the iCWSI and hybrid methods to recalculate the prescriptions of experimental plots using these methods. No difference was found between the prescription map obtained with canopy temperatures estimated by ANNs and the prescription map obtained with canopy temperatures measured by IRTs. Hence, the accuracy of all ANNs tested in the first case study can be deemed as satisfactory.

Regarding the second case study, the scan started on July 24 at 11 h at an angle of 52°. The center pivot then advanced in a counter-clockwise direction through the NNW side of the field and entered the SSE side at approximately 12.5 h. The scan was completed at 13.7 h when the pivot arrived at 68°. Similar to the first case study, measured canopy temperatures tended to be smaller as the center pivot advanced through the SSE side of the field, i.e., after 12.5 h. As in the first case, ANNs were capable of approximating the oscillating pattern displayed by canopy temperatures through the scan (FIG. 4), with a RMSE that ranged from 2.14° C. to 2.77° C. as shown in Table 2.

TABLE 2
Root Mean Squared Error (RMSE) of ANNs used in the second
case study to forecast average canopy temperatures measured
by IRT groups during the scan performed on July 24

| | Root Mean Squared Error (RMSE) | | | | | |
|---|---|---|---|---|---|---|
| | IRT | IRT | IRT | IRT | IRT | IRT |
| | Group | Group | Group | Group | Group | Group |
| | 1 | 2 | 3 | 4 | 5 | 6 |
| All irrigation | 2.77 | 2.64 | 2.72 | 2.18 | 2.14 | 2.42 |
| levels | | | | | | |
| 30% irrigation | 3.20 | 3.29 | 5.04 | 2.30 | 3.07 | 3.78 |
| level | | | | | | |
| 50% irrigation | 2.52 | 1.34 | 2.40 | 2.29 | 2.12 | 1.28 |
| level | | | | | | |
| 80% irrigation | 2.72 | 2.70 | 1.67 | 2.11 | 1.81 | 2.15 |
| level | | | | | | |

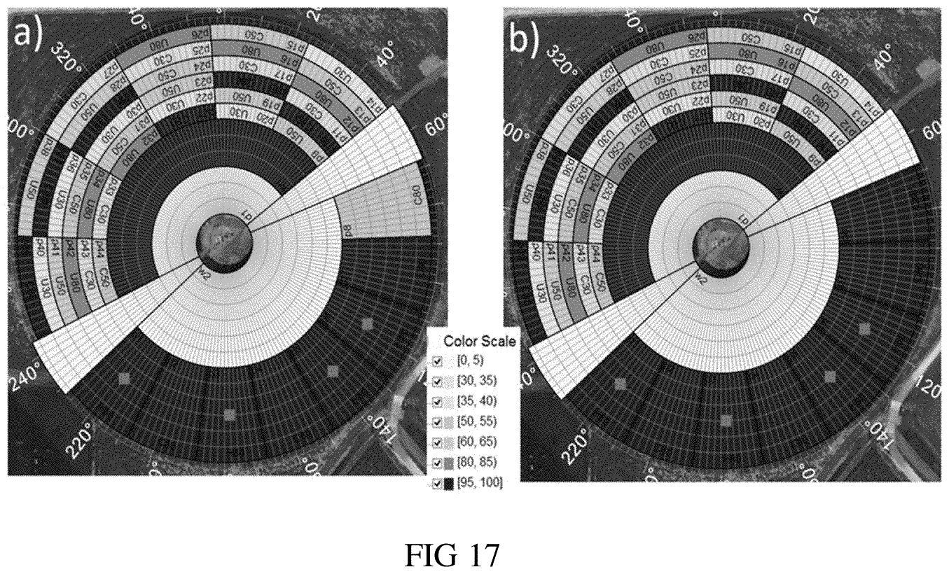

When comparing the prescription maps obtained with canopy temperatures estimated by ANNs and canopy temperatures measured by IRTs, only one plot (out of 26 assigned either the iCWSI or hybrid methods) was assigned a different prescription (per FIG. 17). Therefore, the accuracy of all ANNs tested in the second case study can be also deemed as satisfactory.

For the foregoing reasons, it is clear that the method and apparatus described herein provides an innovative system and method of watering crops with a variable rate irrigation system. The method may be modified in multiple ways and applied in various technological applications. As noted above, although the preferred embodiment focuses on IRT data from IRTs positioned on the irrigation pipe of the center pivot, other irrigation variable data can also be projected using the described ANN process. The disclosed method and apparatus may be modified and customized as required by a specific operation or application, and the individual components may be modified and defined, as required, to achieve the desired result.

Although the materials of construction are not described, they may include a variety of compositions consistent with the function described herein. Such variations are not to be regarded as a departure from the spirit and scope of this disclosure, and all such modifications as would be obvious to one skilled in the art are intended to be included within the scope of the following claims.

The amounts, percentages and ranges disclosed herein are not meant to be limiting, and increments between the recited amounts, percentages and ranges are specifically envisioned as part of the invention. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all sub-ranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Similarly, if the term “about” precedes a numerically quantifiable measurement, that measurement is assumed to vary by as much as 10%. Essentially, as used herein, the term “about” refers to a quantity, level, value, or amount that varies by as much 10% to a reference quantity, level, value, or amount.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element which is not specifically disclosed herein.

What is claimed is:

1. A method of irrigating a selected field, the method comprising:
(a) identifying and defining the field;
(b) constructing an automated irrigation system to irrigate the field;
(c) providing an irrigation plan used by the irrigation system to irrigate the field, the irrigation plan being generated based on multiple irrigation variables;
(d) if at least one irrigation variable in step (c) is unavailable, using a machine learning algorithm, such as an artificial neural network (ANN), to generate the unavailable irrigation variable and subsequently generating a projected irrigation plan; and,
(e) irrigating the field based on the projected irrigation plan of step (d).

2. The method of claim 1 wherein, in step (a), the field comprises a circular field.

3. The method of claim 1 wherein, in step (b), the automated irrigation system comprises a circular center pivot irrigation system.

4. The method of claim 1 wherein, in step (b), the automated irrigation system comprises a variable rate irrigation system (VRI).

5. The method of claim 4 wherein the VRI is equipped with an Irrigation Scheduling Supervisory Control and Data Acquisition System (ISSCADAS).

6. The method of claim 1 wherein, in step (b), the automated irrigation system comprises a center pivot irrigation system with infrared thermometers (IRTs) mounted on a center pivot pipe that sweeps around a circumference of the field.

7. The method of claim 6 wherein 3 pairs of IRTs are mounted on the center pivot pipe, each pair of the IRTs comprising two oppositely facing IRTs.

8. The method of claim 1 wherein, in step (d), the unavailable irrigation variable comprises average canopy temperature conventionally measured by IRTs mounted on a center pivot pipe, so that the ANN generates an average canopy temperature value for each of three pairs of IRTs.

9. The method of claim 1 wherein, in step (d), the unavailable irrigation variable is at least one of: air temperature measured at time t during a scan, relative humidity at time t, solar irradiance at time t, wind direction at time t, wind speed at time t, average canopy temperature measured by stationary IRTs at time t, irrigation level (%) assigned to the experimental plot p being scanned by a pair of IRTs at time t, irrigation scheduling method assigned to plot p, the number of days passed since planting at the time of the scan, cumulative irrigation (including precipitation) received by a selected experimental plot p, and/or a value for crop water stress index (iCWSI).

10. The method of claim 1 wherein, in step (c) and thereafter, an irrigation plan comprises an irrigation prescription map.

11. A system for irrigating a field, the system comprising:
a VRI system equipped with ISSCADAS, the ISSCADAS being programed with software to generate an irrigation prescription map based on multiple irrigation variables;
a center pivot pipe comprising IRTs for measuring average canopy temperature, average canopy temperature comprising an irrigation variable;
wherein, in the absence of a measured average canopy temperature, the ISSCADAS uses a machine learning-generated predicted average canopy temperature value to generate the irrigation prescription map.
